(19) United States
(12) Patent Application Publication
(10) Pub. No.: US 2013/0128821 A1
(43) Pub. Date: May 23, 2013

(54) Demodulation Reference Signal Arrangement For Uplink Coordinated Multi-Point Reception

(71) Applicants: Kari J. Hooli, Oulu (FI); Kari P. Pajukoski, Oulu (FI); Esa T. Tiirola, Kempele (FI); Mauri J. Nissila, Oulu (FI)

(72) Inventors: Kari J. Hooli, Oulu (FI); Kari P. Pajukoski, Oulu (FI); Esa T. Tiirola, Kempele (FI); Mauri J. Nissila, Oulu (FI)

(73) Assignee: Nokia Siemens Networks Oy

(21) Appl. No.: 13/299,508

(22) Filed: Nov. 18, 2011

(51) Int. Cl. H04W 72/04

(52) U.S. Cl. 370/329

(57) ABSTRACT

A method for providing a DM RS arrangement for CoMP reception is described. The method includes receiving (e.g., at a receiver), at a UE, a message for a first CC from a network node. The message includes an indication of a DM RS PUSCH mode for the first CC and a CSI field. The method also includes determining (e.g., at a processor) whether the DM RS PUSCH mode for the first CC includes a mirror cell mode. In response to determining that the DM RS PUSCH mode includes a mirror cell mode, the method includes determining (e.g., at a processor) a DM RS sequence based at least in part on the CSI field. Apparatus and computer readable media are also described.

### TECHNICAL FIELD

The exemplary and non-limiting embodiments of this invention relate generally to wireless communication systems, methods, devices and computer programs and, more specifically, relate to a DM RS arrangement for CoMP reception.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
BS basestation
BW bandwidth
CA carrier aggregation
CC component carrier
CDM code division multiplexing
CIF carrier indicator field
CoMP coordinated multi-point
CS cyclic shift
CSI cyclic shift indicator
DCI downlink control information
DL downlink (eNB towards UE)
DM RS demodulation reference signal
eNB E-UTRAN Node B (evolved Node B)
EPC evolved packet core
E-UTRAN evolved UTRAN (LTE)
HARQ hybrid automatic repeat request
IFDM interleaved frequency division multiplexing
IMT-A international mobile telephony-advanced
ITU international telecommunication union
ITU-R ITU radiocommunication sector
LTE long term evolution of UTRAN (E-UTRAN)
MAC medium access control (layer 2, L2)
MIMO multiple input multiple output
MM/MME mobility management/mobility management entity
MU-MIMO multi-user multiple input multiple output
Node B base station
O&M operations and maintenance
OCC orthogonal cover code
OFDMA orthogonal frequency division multiple access
PDCP packet data convergence protocol
PHICH physical HARQ indicator channel
PHY physical (layer 1, L1)
PRB physical resource block
PUSCH physical uplink shared channel
RAN 1 technical specification group radio access network working group 1
Rel release
RLC radio link control
RPF repetition factor
RRC radio resource control
RRM radio resource management
SC-FDMA single carrier, frequency division multiple access
S-GW serving gateway
SINR signal to interference and noise ratio
SU-MIMO single-user multiple input multiple output
UE user equipment, such as a mobile station or mobile terminal
UL uplink (UE towards eNB)
UTRA universal terrestrial radio access
UTRAN universal terrestrial radio access network

The specification of a communication system known as evolved UTRAN (E-UTRAN, also referred to as UTRAN-LTE or as E-UTRA) is currently nearing completion within the 3GPP. As specified the DL access technique is OFDMA, and the UL access technique is SC-FDMA.

One specification of interest is 3GPP TS 36.300, V8.12.0 (2010-04), “3rd Generation Partnership Project; Technical Specification Group Radio Access Network; Evolved Universal Terrestrial Radio Access (E UTRA) and Evolved Universal Terrestrial Access Network (E UTRAN); Overall description; Stage 2 (Release 8),” incorporated by reference herein in its entirety. This system may be referred to for convenience as LTE Rel-8 (which also contains 3G HSPA and its improvements). In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.8.0 (2011-10), incorporated by reference herein in its entirety. Even more recently, Release 10 versions of at least some of these specifications have been published including 3GPP TS 36.300, V10.5.0 (2011 10), incorporated by reference herein in its entirety.

FIG. 1 reproduces FIG. 4-1 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE (not shown). The eNBs are interconnected with each other by means of an X2 interface. The eNBs are also connected by means of an S1 interface to an EPC, more specifically to a MME (Mobility Management Entity) by means of a

S1 MME interface and to a Serving Gateway (SGW) by means of a S1 interface. The S1 interface supports a many-to-many relationship between MMEs/S-GW and eNBs.

The eNB hosts the following functions:
functions for RRM: Radio Bearer Control, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the Serving Gateway;
scheduling and transmission of paging messages (originated from the MME);
scheduling and transmission of broadcast information (originated from the MME or O&M); and
a measurement and measurement reporting configuration for mobility and scheduling.

Of particular interest herein are the further releases of 3GPP LTE (e.g., LTE Rel-10) targeted towards future IMT-A systems, referred to herein for convenience simply as LTE-Advanced (LTE-A). Reference in this regard may be made to 3GPP TR 36.913, V8.0.1 (2009 03), 3rd Generation Partnership Project; Technical Specification Group Radio Access Network; Requirements for Further Advancements for E UTRA (LTE-Advanced) (Release 8), incorporated by reference herein in its entirety. A goal of LTE-A is to provide significantly enhanced services by means of higher data rates and lower latency with reduced cost. LTE-A is directed toward extending and optimizing the 3GPP LTE Rel-8 radio access technologies to provide higher data rates at very low cost. LTE-A will most likely be part of LTE Rel-10. LTE-A will be a more optimized radio system fulfilling the ITU-R requirements for IMT-A while maintaining backward compatibility with LTE Rel-8. Reference is further made to a Release 9 version of 3GPP TR 36.913, V9.0.0 (2009-12), incorporated by reference herein in its entirety. Reference is also made to a Release 10 version of 3GPP TR 36.913, V10.0.0 (2011-06), incorporated by reference herein in its entirety.

As is specified in 3GPP TR 36.913, LTE-A should operate in spectrum allocations of different sizes, including wider spectrum allocations than those of Rel-8 LTE (e.g., up to 100 MHz) to achieve the peak data rate of 100 Mbit/s for high mobility and 1 Gbit/s for low mobility. It has been agreed that carrier aggregation is to be considered for LTE-A in order to support bandwidths larger than 20 MHz. Carrier aggregation, where two or more component carriers (CCs) are aggregated, is considered for LTE-A in order to support transmission bandwidths larger than 20 MHz. The carrier aggregation could be contiguous or non-contiguous. This technique, as a bandwidth extension, can provide significant gains in terms of peak data rate and cell throughput as compared to non-aggregated operation as in LTE Rel-8.

A terminal may simultaneously receive one or multiple component carriers depending on its capabilities. A LTE-A terminal with reception capability beyond 20 MHz can simultaneously receive transmissions on multiple component carriers. A LTE Rel-8 terminal can receive transmissions on a single component carrier only, provided that the structure of the component carrier follows the Rel-8 specifications. Moreover, it is required that LTE-A should be backwards compatible with Rel-8 LTE in the sense that a Rel-8 LTE terminal should be operable in the LTE-A system, and that a LTE-A terminal should be operable in a Rel-8 LTE system.

FIG. 2 shows an example of the carrier aggregation, where M Rel-8 component carriers are combined together to form M×Rel-8 BW (e.g., 5×20 MHz=100 MHz given M=5). Rel-8 terminals receive/transmit on one component carrier, whereas LTE-A terminals may receive/transmit on multiple component carriers simultaneously to achieve higher (wider) bandwidths.

With further regard to carrier aggregation, what is implied is that one UE can be configured to receive or transmit on more than one cell corresponding to more than one CC (component carrier), and the eNB can dynamically utilize one (as in E-UTRAN Rel-8) or more cells (in an aggregated manner) when assigning resources and scheduling the UE.

Coordinated multi-point (CoMP) reception is considered for LTE-A as a tool to improve the coverage of high data rates. In this type of system, multiple geographically separated points and antenna(s) at these points receive signals from multiple UEs. The signals then need to be combined in order to determine data from the UEs. Typical techniques for combining these signals can be very complex.

Uplink CoMP implies reception of a transmitted signal at multiple points which are generally geographically separated. Uplink CoMP reception is expected to have very limited impact on the RAN1 specifications. However, it has been shown that gains of UL CoMP joint reception may be affected by channel estimation errors, and that those channel estimation errors may be considerably reduced with use of inter-cell orthogonal demodulation reference signal (DM RS).

Configuration of inter-cell orthogonal DM RS is supported in LTE Rel-8. However, the orthogonality is based on cyclic shifts. Thus, the physical resource block (PRB) allocation is limited to be same for all orthogonal UEs. This poses significant scheduling restrictions, especially with CoMP clusters covering multiple cells, for example, requiring the same PRB allocation to at least a corresponding number of UEs. Such scheduling restrictions may limit gains from frequency domain packet scheduling.

In Rel-10, this restriction was relaxed with introduction of orthogonal cover code (OCC). However, the dimension of OCC is limited to two. Two dimensions are sufficient for intra-cell MU-MIMO pairing but insufficient for flexible scheduling within a CoMP cluster of three or more cells.

Additionally, when OCC is enabled, sequence group hopping is disabled either on a per cell or per UE level. In networks employing sequence group hopping as an inter-cell DM RS randomization method, this restriction may be seen as reasonable since the OCC would be enabled for cell-center UEs with a reasonably high signal to interference and noise ratio (SINR). Therefore, the UE should encounter acceptable channel estimation errors. However, when CoMP is used, support for sequence group hopping between different CoMP clusters may be more relevant as cell edge UEs with considerably lower SINR are involved.

Various techniques have been attempted to increase orthogonal DM RS flexibility. Interleaved frequency division multiplexing (IFDM) may be used to increase inter-cell orthogonal DM RS flexibility with respect to PRB allocations. The use of a DCI CIF field in cell aggregation based CoMP may be employed to dynamically select the used sequence group. Another option is that the DM RS base sequence (or, more broadly, the DM RS configuration) can be decoupled from a physical cell identity and can be dynamically changed. A further option is to perform sequence group hopping at a subframe-rate for CoMP UEs.

What is needed is a way to arrange signaling for DM RS that both supports inter-cell orthogonality with legacy terminals and provides enhanced scheduling flexibility.

### SUMMARY

The below summary section is intended to be merely exemplary and non-limiting.

The foregoing and other problems are overcome, and other advantages are realized, by the use of the exemplary embodiments of this invention.

In a first aspect thereof an exemplary embodiment of this invention provides a method for signaling a DM RS arrangement for CoMP reception. The method includes receiving (e.g., at a receiver), at a UE, a message for a first CC from a network node. The message includes an indication of a DM RS PUSCH mode for the first CC and a CSI field. The method also includes determining (e.g., at a processor) whether the DM RS PUSCH mode for the first CC includes a mirror cell mode. In response to determining that the DM RS PUSCH mode includes a mirror cell mode, the method includes determining (e.g., at a processor) a DM RS sequence based at least in part on the CSI field.

In another aspect thereof an exemplary embodiment of this invention provides an apparatus for signaling a DM RS arrangement for CoMP reception. The apparatus includes at least one processor; and at least one memory including computer program code. The at least one memory and the computer program code are configured to, with the at least one processor, cause the apparatus to perform actions. The actions include receiving, at a UE, a message for a first CC from a network node. The message includes an indication of a DM RS PUSCH mode for the first CC and a CSI field. The actions also include determining whether the DM RS PUSCH mode for the first CC includes a mirror cell mode. In response to determining that the DM RS PUSCH mode includes a mirror cell mode, the actions include determining a DM RS sequence based at least in part on the CSI field.

In a further aspect thereof an exemplary embodiment of this invention provides a computer readable medium for signaling a DM RS arrangement for CoMP reception. The computer readable medium is tangibly encoded with a computer program executable by a processor to perform actions. The actions include receiving, at a UE, a message for a first CC from a network node. The message includes an indication of a DM RS PUSCH mode for the first CC and a CSI field. The actions also include determining whether the DM RS PUSCH mode for the first CC includes a mirror cell mode. In response to determining that the DM RS PUSCH mode includes a mirror cell mode, the actions include determining a DM RS sequence based at least in part on the CSI field.

In another aspect thereof an exemplary embodiment of this invention provides an apparatus for signaling a DM RS arrangement for CoMP reception. The apparatus includes means for receiving (e.g., a receiver), at a UE, a message for a first CC from a network node. The message includes an indication of a DM RS PUSCH mode for the first CC and a CSI field. The apparatus also includes means for determining (e.g., a processor) whether the DM RS PUSCH mode for the first CC includes a mirror cell mode. In response to determining that the DM RS PUSCH mode includes a mirror cell mode, the apparatus includes means for determining (e.g., a processor) a DM RS sequence based at least in part on the CSI field.

In a further aspect thereof an exemplary embodiment of this invention provides a method for signaling a DM RS arrangement for CoMP reception. The method includes determining (e.g., at a processor) whether a DM RS PUSCH mode for a first CC includes a mirror cell mode. In response to determining that the DM RS PUSCH mode includes a mirror cell mode, the method includes determining (e.g., at a processor) a CSI field based at least in part on a DM RS sequence and the mirror cell mode. The method also includes generating (e.g., at a processor) a message comprising the CSI field and an indication of the DM RS PUSCH mode. The method also includes transmitting (e.g., at a transmitter), to a UE, a message for a first CC from a network node. The CA configuration message includes the indication of the DM RS PUSCH mode for the first CC and the CSI field.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 reproduces FIG. 4-1 of 3GPP TS 36.300, and shows the overall architecture of the E UTRAN system.

FIG. 2 shows an example of carrier aggregation as proposed for the LTE-A system.

FIG. 3 illustrates a simplified block diagram of exemplary electronic devices that are suitable for use in practicing various exemplary embodiments of this invention.

FIG. 4 illustrates a more particularized block diagram of an exemplary user equipment such as that shown at FIG. 3.

FIG. 5 shows a table for exemplary CSI combinations for IFDM (RPF=2), OCC and CS (N=2) in accordance with this invention.

FIG. 6 shows a table for another exemplary CSI combinations for IFDM (RPF=4) and OCC in accordance with this invention.

FIG. 7 illustrates message fields for use in practicing various exemplary embodiments of this invention.

FIG. 8 is a logic flow diagram that illustrates the operation of an exemplary method, and a result of execution of computer program instructions embodied on a computer readable memory, in accordance with various exemplary embodiments of this invention.

### DETAILED DESCRIPTION

Various exemplary embodiments in accordance with this invention enable signaling for DM RS that both supports inter-cell orthogonality with legacy terminals and provides enhanced scheduling flexibility. For example, various embodiments support inter-cell orthogonality with few scheduling restrictions. Additionally, various embodiments may be used with legacy terminals. Accordingly, legacy features, such as sequence group hopping and carrier aggregation are supported.

While exemplary embodiments are described in the context of an uplink (UL) demodulation reference signal (DM RS) arrangement, it should be appreciated that the exemplary embodiments of this invention are not limited for use with only this particular embodiment.

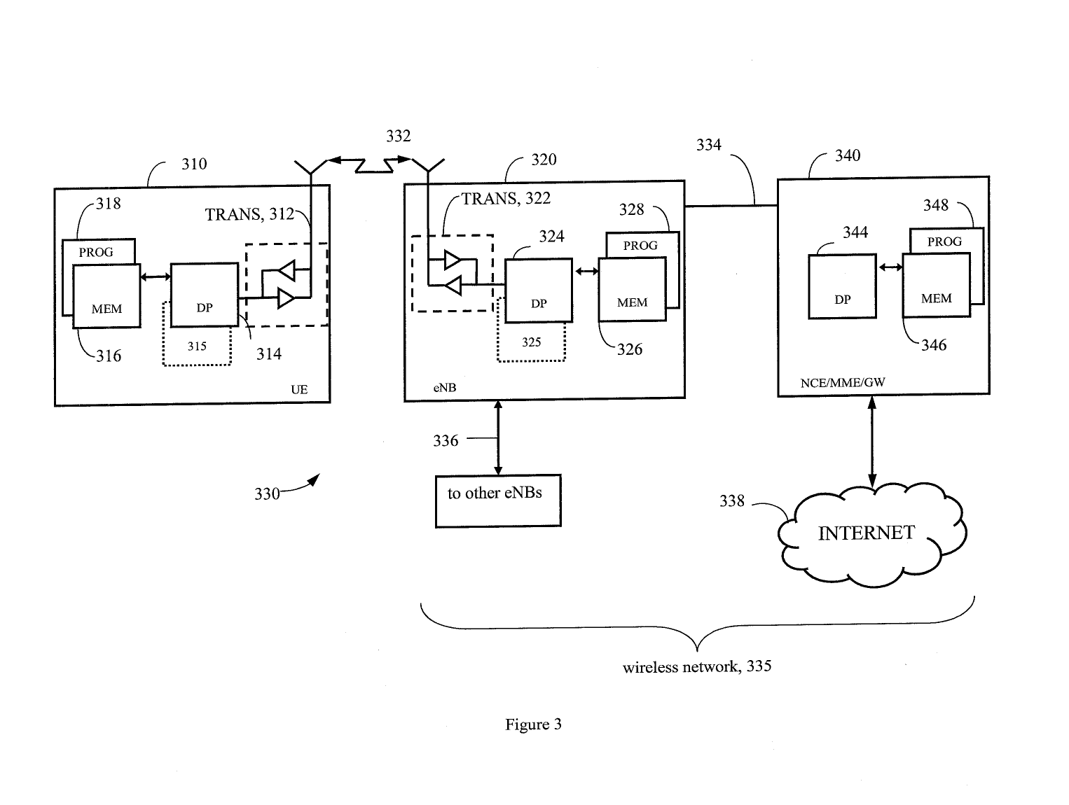

Before describing in further detail various exemplary embodiments of this invention, reference is made to FIG. 3 for illustrating a simplified block diagram of various electronic devices and apparatus that are suitable for use in practicing exemplary embodiments of this invention.

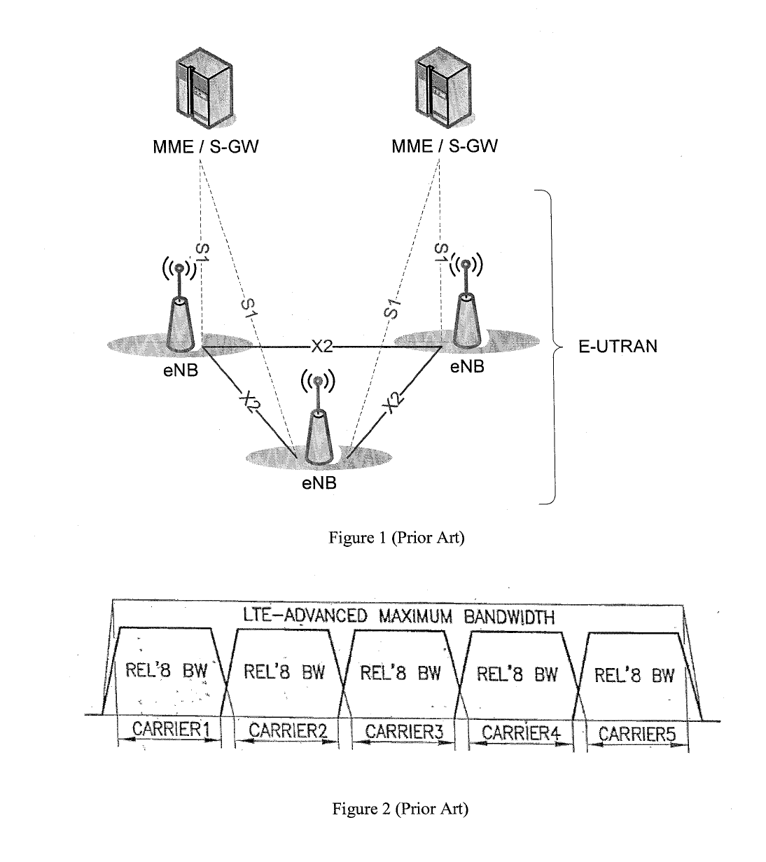

In the wireless system 330 of FIG. 3, a wireless network 335 is adapted for communication over a wireless link 332 with an apparatus, such as a mobile communication device which may be referred to as a UE 310, via a network access node, such as a Node B (base station), and more specifically an eNB 320. The network 335 may include a network control element (NCE) 340 that may include the MME/SGW functionality shown in FIG. 1, and which provides connectivity with a network, such as a telephone network and/or a data communications network (e.g., the internet 338).

The UE 310 includes a controller, such as a computer or a data processor (DP) 314, a computer-readable memory medium embodied as a memory (MEM) 316 that stores a program of computer instructions (PROG) 318, and a suitable wireless interface, such as radio frequency (RF) transceiver 312, for bidirectional wireless communications with the eNB 320 via one or more antennas.

The eNB 320 also includes a controller, such as a computer or a data processor (DP) 324, a computer-readable memory medium embodied as a memory (MEM) 326 that stores a program of computer instructions (PROG) 328, and a suitable wireless interface, such as RF transceiver 322, for communication with the UE 310 via one or more antennas. The eNB 320 is coupled via a data/control path 334 to the NCE 340. The path 334 may be implemented as the Si interface shown in FIG. 1. The eNB 320 may also be coupled to another eNB via data/control path 336, which may be implemented as the X2 interface shown in FIG. 1.

The NCE 340 includes a controller, such as a computer or a data processor (DP) 344, a computer-readable memory medium embodied as a memory (MEM) 346 that stores a program of computer instructions (PROG) 348.

At least one of the PROGs 318, 328 and 348 is assumed to include program instructions that, when executed by the associated DP, enable the device to operate in accordance with exemplary embodiments of this invention, as will be discussed below in greater detail.

That is, various exemplary embodiments of this invention may be implemented at least in part by computer software executable by the DP 314 of the UE 310; by the DP 324 of the eNB 320; and/or by the DP 344 of the NCE 340, or by hardware, or by a combination of software and hardware (and firmware).

The UE 310 and the eNB 320 may also include dedicated processors, for example CA unit 315 and CA unit 325.

In general, the various embodiments of the UE 310 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 316, 326 and 346 may be of any type suitable to the local technical environment and may be implemented using any suitable data storage technology, such as semiconductor based memory devices, flash memory, magnetic memory devices and systems, optical memory devices and systems, fixed memory and removable memory. The DPs 314, 324 and 344 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 312 and 322) may be of any type suitable to the local technical environment and may be implemented using any suitable communication technology such as individual transmitters, receivers, transceivers or a combination of such components.

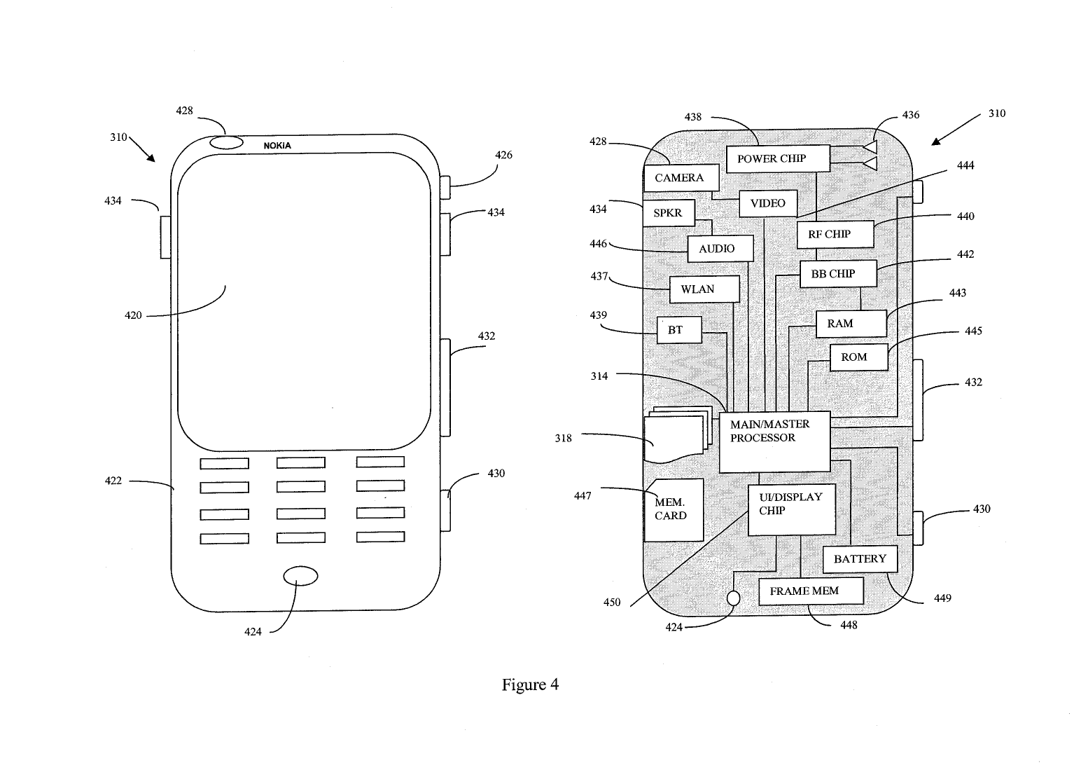

FIG. 4 illustrates further detail of an exemplary UE in both plan view (left) and sectional view (right), and the invention may be embodied in one or some combination of those more function-specific components. At FIG. 4 the UE 310 has a graphical display interface 420 and a user interface 422 illustrated as a keypad but understood as also encompassing touch-screen technology at the graphical display interface 420 and voice-recognition technology received at the microphone 424. A power actuator 426 controls the device being turned on and off by the user. The exemplary UE 310 may have a camera 428 which is shown as being forward facing (e.g., for video calls) but may alternatively or additionally be rearward facing (e.g., for capturing images and video for local storage). The camera 428 is controlled by a shutter actuator 430 and optionally by a zoom actuator 432 which may alternatively function as a volume adjustment for the speaker(s) 434 when the camera 428 is not in an active mode.

Within the sectional view of FIG. 4 are seen multiple transmit/receive antennas 436 that are typically used for cellular communication. The antennas 436 may be multi-band for use with other radios in the UE. The operable ground plane for the antennas 436 is shown by shading as spanning the entire space enclosed by the UE housing though in some embodiments the ground plane may be limited to a smaller area, such as disposed on a printed wiring board on which the power chip 438 is formed. The power chip 438 controls power amplification on the channels being transmitted and/or across the antennas that transmit simultaneously where spatial diversity is used, and amplifies the received signals. The power chip 438 outputs the amplified received signal to the radio-frequency (RF) chip 440 which demodulates and downconverts the signal for baseband processing. The baseband (BB) chip 442 detects the signal which is then converted to a bit-stream and finally decoded. Similar processing occurs in reverse for signals generated in the apparatus 310 and transmitted from it.

Signals to and from the camera 428 pass through an image/video processor 444 which encodes and decodes the various image frames. A separate audio processor 446 may also be present controlling signals to and from the speakers 434 and the microphone 424. The graphical display interface 420 is refreshed from a frame memory 448 as controlled by a user interface chip 450 which may process signals to and from the display interface 420 and/or additionally process user inputs from the keypad 422 and elsewhere.

Certain embodiments of the UE 310 may also include one or more secondary radios such as a wireless local area network radio WLAN 437 and a Bluetooth® radio 439, which may incorporate an antenna on-chip or be coupled to an off-chip antenna. Throughout the apparatus are various memories such as random access memory RAM 443, read only memory ROM 445, and in some embodiments removable memory such as the illustrated memory card 447. The various programs 318 are stored in one or more of these memories. All of these components within the UE 310 are normally powered by a portable power supply such as a battery 449. Processors 438, 440, 442, 444, 446, 450, if embodied as separate entities in a UE 310 or eNB 320, may operate in a slave relationship to the main processor 314, 324, which may then be in a master relationship to them. Embodiments of this invention are most relevant to the DP 314, DP 324, CA unit 315, CA unit 325, power chip 438, RF chip 440 and BB chip 442, though it is noted that other embodiments need not be disposed there but may be disposed across various chips and memories as shown or disposed within another processor that combines some of the functions described above for FIG. 4. Any or all of these various processors of FIG. 4 access one or more of the various memories, which may be on-chip with the processor or separate therefrom. Similar function-specific components that are directed toward communications over a network broader than a piconet (e.g., components 436, 438, 440, 442-445 and 447) may also be disposed in exemplary embodiments of the access node 320, which may have an array of tower-mounted antennas rather than the two shown at FIG. 4.

Note that the various chips (e.g., 438, 440, 442, etc.) that were described above may be combined into a fewer number than described and, in a most compact case, may all be embodied physically within a single chip.

Various exemplary embodiments in accordance with this invention introduce a new DM RS physical uplink shared channel (PUSCH) mode. This DM RS mode can support legacy features and new features such as IFDM, a new DM RS sequence design (which can provide extended scheduling flexibility) and/or subframe-rate sequence group hopping (which provides better inter-CoMP cluster randomization while using OCC). As an example, a new DM RS PUSCH mode can use a DM RS sequence that is determined differently than basic DM RS sequence (e.g. according to 3GPP R1-114324), a sequence hopping pattern and/or a cyclic shift hopping pattern that is determined differently than in basic DM RS mode (e.g. the initialization of the hopping patterns is configured separately for the new DM RS mode via higher layer RRC signaling).

To enable the dynamic signaling for new DM RS PUSCH mode, UE may be configured to carrier and/or cell aggregation (CA). A UE-specific CA configuration may contain an UL specific carrier indicator field (CIF) configuration. The same cell can be mapped to multiple CIF values configured for the UE. A basic cell instance indicates ‘normal’ (or legacy) DM RS operation, whereas a ‘mirror’ cell instance indicates use of the alternative DM RS mode which also may use a different interpretation of the CSI field.

When the CIF indicates use of the alternative DM RS mode, the CSI field is used to indicate an OCC, IFDM comb, and cyclic shift combination. In an alternate embodiment, the CSI field can point to all OCC and IFDM comb combinations, and additionally to one or two cyclic shifts for each OCC and IFDM combination.

Use of the modes may be indicated by radio resource control (RRC) signaling. When the UE receives such signaling, further messages will be examined to determine whether the CIF configuration indicates a basic mode or mirror mode.

In the legacy mode, there is not necessarily a CIF field (e.g., when a carrier aggregation utilizing cross-carrier scheduling is not configured). When CIF is used in the legacy mode there may be some limitations of the CIF values during any uncertainty times when the eNB may have just performed a new configuration/(re-configuration).

When various modes are activated, it will limit the number of CIF values usable for component carriers in the legacy mode. It may also limit the number of CIF values for component carriers on which the alternative DM RS mode is used. Since the original CIF field is over-dimensioned (e.g., there are more CIF values than component carriers that can be practically used) and the mirror cell can be assigned to any CIF value, the use of mirror cell mode is more flexible than e.g. reserving one bit from the CIF for a DM RS mode indication.

In an exemplary embodiment, when the DM RS PUSCH mode is a mirror mode, the CSI field indicates an IFDM comb. When there are two IFDM combs possible, four OCC and IFDM combinations with two cyclic shifts supported for each OCC/IFDM combination may be indicated using a three bit CSI field.

The isolation between cyclic shifts may be maximized by having the difference between cyclic shifts set to CS=L/(RPF*N), where L is the length of DM RS sequence (in time) and RPF is a repetition factor (e.g., the number of available IFDM combs) and N is number of allocated cyclic shifts.

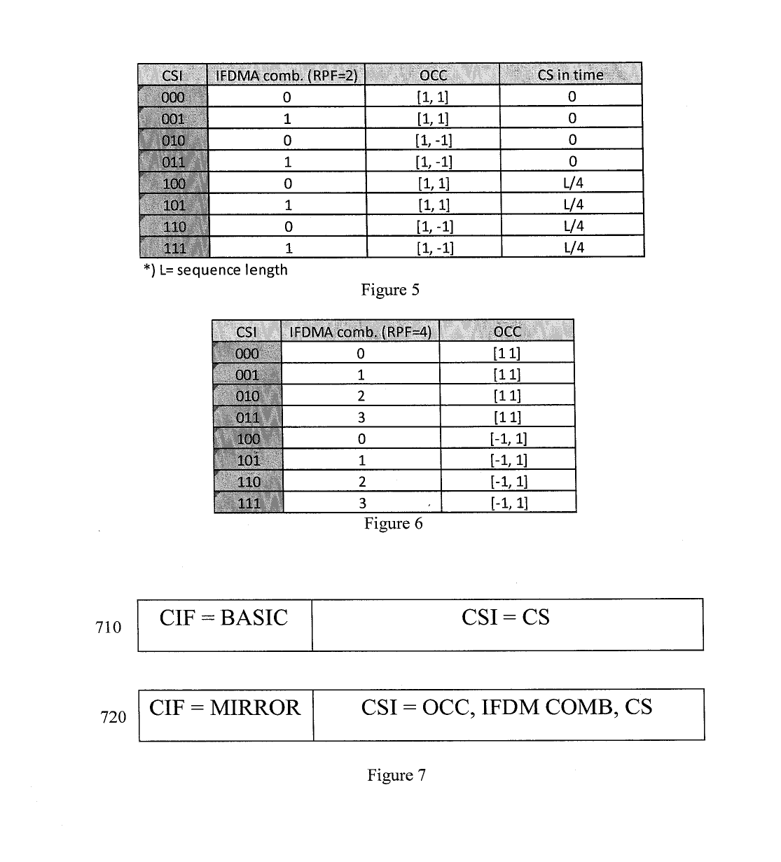

FIG. 5 shows a table for exemplary CSI combinations for IFDM (RPF=2), OCC and CS (N=2) in accordance with this invention. The exemplary CSI design uses a three bit CSI field.

FIG. 6 shows a table for another exemplary CSI combinations for IFDM (RPF=4) and OCC in accordance with this invention. This second CSI design also uses a three bit CSI field. In this design, cyclic shifts are reserved for SU-MIMO operation.

In an embodiment in accordance with this invention, the CSI values providing a desired physical HARQ indicator channel (PHICH) resource separation are allocated to the same comb/OCC combination (e.g., by permutating the rows of the tables in FIGS. 5 and 6. There may be a one-to-one mapping between the CSI and the PHICH modifier. The same comb/OCC combination may indicate a DM RS separation between UEs by cyclic shifts; thus, indicating the use of the same PRB allocation for UEs. This implies a potentially higher risk of collision on PHICH resources.

The CSI may also be used as a PHICH modifier (e.g., the PHICH may be a shared control channel on the DL side conveying a HARQ−ACK for the PUSCH). A PHICH resource may be scalable and the resource is derived according to the first PRB of the PUSCH together with a CSI value. The PHICH resource may be overbooked in a way that the PRBs don't have a dedicated PHICH resource. A PHICH modifier has been introduced to change the PHICH resource in order to avoid a PHICH collision. (MU-MIMO is another potential cause of collisions.)

When IFDM is supported, it is not necessary to derive a new computer searched DM RS sequences for allocations having PRBs less than 3*RPF, excluding PRB allocations of RPF and 2*RPF. For example, if the RPF=2, the PRB allocations of 1, 3, and 5. Instead, a legacy DM RS mode can be dynamically used for these PRB allocations, as dynamic switching between legacy and new DM RS mode is supported.

FIG. 7 illustrates message fields for use in practicing various exemplary embodiments of this invention. In message portion 710, there is a CIF field and a CSI field. The CIF field of message portion 710 indicates a basic cell instance (or basic cell mode). Thus, the CSI field indicates a cyclic shift (CS). The CIF field of message portion 720 indicates a mirror cell instance (or mirror cell mode). Thus, the CSI field indicates an OCC and IFDM comb combination. The CSI field may also indicate a CS to use with the combination.

Various exemplary embodiments in accordance with this invention provide a method to dynamically select between 1) support for inter-cell DM RS orthogonality with legacy terminals and 2) support for an alternative DM RS mode with more flexible PRB allocations.

The use of the CIF (i.e., to indicate a DM RS mode as “mirror” cell) provides dynamic support for the alternative DM RS mode while other Rel 10 features like carrier aggregation can be simultaneously supported without requiring a new DCI format size. Accordingly, greater flexibility between normal CA configuration and configuration of the alternative DM RS mode is enabled. For example, the UE can be configured for up to five CCs with the alternative DM RS mode supported on three of these CC. Additionally, if the UE is configured for up to four CCs, the alternative DM RS mode can be supported on all four CCs.

When the IFDM is supported, DM RS sequences for various small PRB allocations are supported via use of the legacy DM RS mode.

Based on the foregoing it should be apparent that the exemplary embodiments of this invention provide a method, apparatus and computer program(s) to provide a DM RS arrangement for CoMP reception.

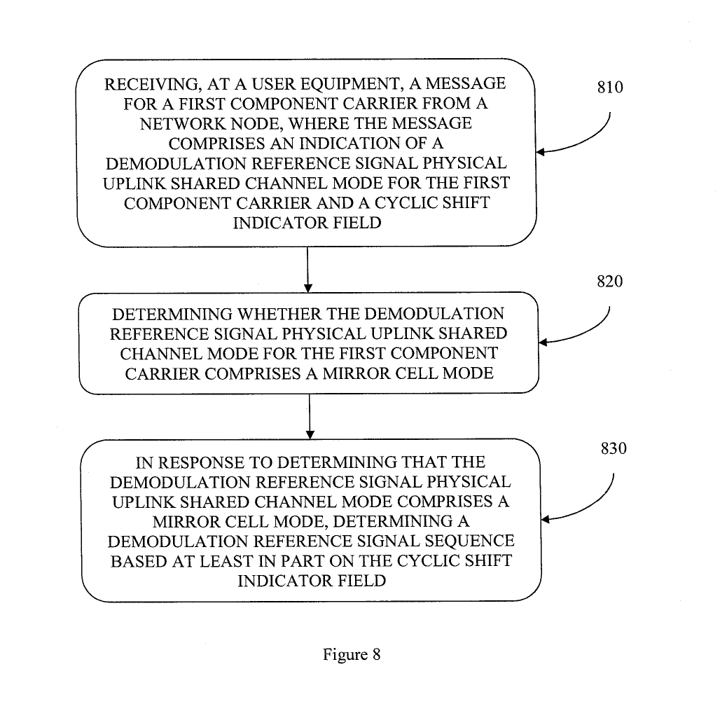

FIG. 8 is a logic flow diagram that illustrates the operation of a method, and a result of execution of computer program instructions, in accordance with the exemplary embodiments of this invention. In accordance with these exemplary embodiments a method performs, at Block 810, a step of receiving, at a user equipment, a message for a first component carrier from a network node. The message comprises an indication of a demodulation reference signal physical uplink shared channel mode for the first component carrier and a cyclic shift indicator field. The method also performs, at Block 820, a step of determining whether the demodulation reference signal physical uplink shared channel mode for the first component carrier comprises a mirror cell mode. In response to determining that the demodulation reference signal physical uplink shared channel mode comprises a mirror cell mode, the method performs, at Block 830, a step of determining a demodulation reference signal sequence based at least in part on the cyclic shift indicator field.

The various blocks shown in FIG. 8 may be viewed as method steps, and/or as operations that result from operation of computer program code, and/or as a plurality of coupled logic circuit elements constructed to carry out the associated function(s).

An exemplary embodiment in accordance with this invention is a method for providing a DM RS arrangement for CoMP reception. The method includes receiving (e.g., at a receiver), at a UE, a message for a first CC from a network node. The message includes an indication of a DM RS PUSCH mode for the first CC and a CSI field. The method also includes determining (e.g., at a processor) whether the DM RS PUSCH mode for the first CC includes a mirror cell mode. In response to determining that the DM RS PUSCH mode includes a mirror cell mode, the method includes determining (e.g., at a processor) a DM RS sequence based at least in part on the CSI field.

In a further exemplary embodiment of the method above, determining the DM RS sequence includes determining an OCC and an IFDM comb combination for the first CC. Determining the DM RS sequence may further include determining a CS for the OCC and the IFDM comb combination based at least in part on the CSI field.

In an additional exemplary embodiment of any one of the methods above, the method also includes determining whether the DM RS PUSCH mode for the first CC includes a basic cell instance; and in response to determining that the DM RS PUSCH mode includes a basic cell instance, determining a DM RS sequence based at least in part on the CSI field.

In a further exemplary embodiment of any one of the methods above, the message is received via RRC signaling.

In an additional exemplary embodiment of any one of the methods above, the CA includes an aggregation of the first CC and at least one other CCs; and the method further includes receiving CA configuration messages for each of the at least one other CCs.

In a further exemplary embodiment of any one of the methods above, the method also includes transmitting, from the UE, a message for CoMP reception based on the determined DM RS sequence.

In an additional exemplary embodiment of any one of the methods above, the indication of a DM RS PUSCH mode includes an UL specific carrier indicator field.

In a further exemplary embodiment of any one of the methods above, the message includes a CA configuration message.

In an additional exemplary embodiment of any one of the methods above, the mirror cell mode and basic cell mode use a different DM RS structure.

In a further exemplary embodiment of any one of the methods above, the mirror cell mode and basic cell mode use a different DM RS configuration.

An additional exemplary embodiment in accordance with this invention is an apparatus for providing a DM RS arrangement for CoMP reception. The apparatus includes at least one processor; and at least one memory including computer program code. The at least one memory and the computer program code are configured to, with the at least one processor, cause the apparatus to perform actions. The actions include receiving, at a UE, a message for a first CC from a network node. The message includes an indication of a DM RS PUSCH mode for the first CC and a CSI field. The actions also include determining whether the DM RS PUSCH mode for the first CC includes a mirror cell mode. In response to determining that the DM RS PUSCH mode includes a mirror cell mode, the actions include determining a DM RS sequence based at least in part on the CSI field.

In a further exemplary embodiment of the apparatus above, where, when determining the DM RS sequence, the actions include determining an OCC and an

IFDM comb combination for the first CC. When determining the DM RS sequence, that actions may further include determining a CS for the OCC and the IFDM comb combination based at least in part on the CSI field.

In an additional exemplary embodiment of any one of the apparatus above, the actions also include determining whether the DM RS PUSCH mode for the first CC includes a basic cell instance; and in response to determining that the DM RS PUSCH mode includes a basic cell instance, determining a DM RS sequence based at least in part on the CSI field.

In a further exemplary embodiment of any one of the apparatus above, the message is received via RRC signaling.

In an additional exemplary embodiment of any one of the apparatus above, the CA includes an aggregation of the first CC and at least one other CCs; and the actions further includes receiving CA configuration messages for each of the at least one other CCs.

In a further exemplary embodiment of any one of the apparatus above, the actions also includes transmitting, from the UE, a message for CoMP reception based on the determined DM RS sequence.

In an additional exemplary embodiment of any one of the apparatus above, the indication of a DM RS PUSCH mode includes an UL specific carrier indicator field.

In a further exemplary embodiment of any one of the apparatus above, the message includes a CA configuration message.

In an additional exemplary embodiment of any one of the apparatus above, the apparatus is embodied in an integrated circuit.

In a further exemplary embodiment of any one of the apparatus above, the apparatus is embodied in an a mobile device.

In an additional exemplary embodiment of any one of the apparatus above, the mirror cell mode and basic cell mode use a different DM RS structure.

In a further exemplary embodiment of any one of the apparatus above, the mirror cell mode and basic cell mode use a different DM RS configuration.

An additional exemplary embodiment in accordance with this invention is a computer readable medium for providing a DM RS arrangement for CoMP reception. The computer readable medium is tangibly encoded with a computer program executable by a processor to perform actions. The actions include receiving, at a UE, a message for a first CC from a network node. The message includes an indication of a DM RS PUSCH mode for the first CC and a CSI field. The actions also include determining whether the DM RS PUSCH mode for the first CC includes a mirror cell mode. In response to determining that the DM RS PUSCH mode includes a mirror cell mode, the actions include determining a DM RS sequence based at least in part on the CSI field.

In a further exemplary embodiment of the computer readable medium above, where, when determining the DM RS sequence, the actions include determining an OCC and an IFDM comb combination for the first CC. When determining the DM RS sequence, that actions may further include determining a CS for the OCC and the IFDM comb combination based at least in part on the CSI field.

In an additional exemplary embodiment of any one of the computer readable media above, the actions also include determining whether the DM RS PUSCH mode for the first CC includes a basic cell instance; and in response to determining that the DM RS PUSCH mode includes a basic cell instance, determining a DM RS sequence based at least in part on the CSI field.

In a further exemplary embodiment of any one of the computer readable media above, the message is received via RRC signaling.

In an additional exemplary embodiment of any one of the computer readable media above, the CA includes an aggregation of the first CC and at least one other CCs; and the actions further includes receiving CA configuration messages for each of the at least one other CCs.

In a further exemplary embodiment of any one of the computer readable media above, the actions also includes transmitting, from the UE, a message for CoMP reception based on the determined DM RS sequence.

In an additional exemplary embodiment of any one of the computer readable media above, the indication of a DM RS PUSCH mode includes an UL specific carrier indicator field.

In a further exemplary embodiment of any one of the computer readable media above, the message includes a CA configuration message.

In an additional exemplary embodiment of any one of the computer readable media above, the computer readable media is a non-transitory computer readable media (e.g., CD-ROM, flash memory, RAM, etc.).

In a further exemplary embodiment of any one of the apparatus above, the mirror cell mode and basic cell mode use a different DM RS structure.

In an additional exemplary embodiment of any one of the apparatus above, the mirror cell mode and basic cell mode use a different DM RS configuration.

A further exemplary embodiment in accordance with this invention is an apparatus for providing a DM RS arrangement for CoMP reception. The apparatus includes means for receiving (e.g., a receiver), at a UE, a message for a first CC from a network node. The message includes an indication of a DM RS PUSCH mode for the first CC and a CSI field. The apparatus also includes means for determining (e.g., a processor) whether the DM RS PUSCH mode for the first CC includes a mirror cell mode. In response to determining that the DM RS PUSCH mode includes a mirror cell mode, the apparatus includes means for determining (e.g., a processor) a DM RS sequence based at least in part on the CSI field.

In an additional exemplary embodiment of the apparatus above, the means for determining the DM RS sequence includes means for determining an OCC and an IFDM comb combination for the first CC. The means for determining the DM RS sequence may also include means for determining a CS for the OCC and the IFDM comb combination based at least in part on the CSI field.

In a further exemplary embodiment of any one of the apparatus above, the apparatus also includes means for determining whether the DM RS PUSCH mode for the first CC includes a basic cell instance; and in response to determining that the DM RS PUSCH mode includes a basic cell instance, means for determining a DM RS sequence based at least in part on the CSI field.

In an additional exemplary embodiment of any one of the apparatus above, the message is received via RRC signaling.

In a further exemplary embodiment of any one of the apparatus above, the CA includes an aggregation of the first CC and at least one other CCs; and the apparatus further includes means for receiving CA configuration messages for each of the at least one other CCs.

In an additional exemplary embodiment of any one of the apparatus above, the apparatus also includes means for transmitting, from the UE, a message for CoMP reception based on the determined DM RS sequence.

In a further exemplary embodiment of any one of the apparatus above, the indication of a DM RS PUSCH mode includes an UL specific carrier indicator field.

In an additional exemplary embodiment of any one of the apparatus above, the message includes a CA configuration message.

In a further exemplary embodiment of any one of the apparatus above, the mirror cell mode and basic cell mode use a different DM RS structure.

In an additional exemplary embodiment of any one of the apparatus above, the mirror cell mode and basic cell mode use a different DM RS configuration.

A further exemplary embodiment in accordance with this invention is a method for providing a DM RS arrangement for CoMP reception. The method includes determining (e.g., at a processor) whether a DM RS PUSCH mode for a first CC includes a mirror cell mode. In response to determining that the DM RS PUSCH mode includes a mirror cell mode, the method includes determining (e.g., at a processor) a CSI field based at least in part on a DM RS sequence and the mirror cell mode. The method also includes generating (e.g., at a processor) a message comprising the CSI field and an indication of the DM RS PUSCH mode. The method also includes transmitting (e.g., at a transmitter), to a UE, a message for a first CC from a network node. The CA configuration message includes the indication of the DM RS PUSCH mode for the first CC and the CSI field.

In an additional exemplary embodiment of the method above, the DM RS sequence includes an OCC and an IFDM comb combination for the first CC. The DM RS sequence may also include a CS for the OCC and the IFDM comb combination.

In a further exemplary embodiment of any one of the methods above, the methods also includes determining whether the DM RS PUSCH mode for the first CC includes a basic cell instance; and in response to determining that the DM RS PUSCH mode includes a basic cell instance, determining the CSI field based at least in part on a DM RS sequence.

In an additional exemplary embodiment of any one of the methods above, the message is transmitted via RRC signaling.

In a further exemplary embodiment of any one of the methods above, the CA includes an aggregation of the first CC and at least one other CCs; and the method further includes transmitting CA configuration messages for each of the at least one other CCs.

In an additional exemplary embodiment of any one of the methods above, the methods also includes receiving, from the UE, a message using CoMP reception based on the determined DM RS sequence.

In a further exemplary embodiment of any one of the methods above, the indication of a DM RS PUSCH mode includes an UL specific carrier indicator field.

In an additional exemplary embodiment of any one of the methods above, the message includes a CA configuration message.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems such as for example (WLAN, UTRAN, GSM).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., CSI, HARQ, etc.) are not intended to be limiting in any respect, as these parameters may be identified by any suitable names. Further, the various names assigned to different channels (e.g., PHICH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
receiving, at a user equipment, a message for a first component carrier from a network node,
where the message comprises an indication of a demodulation reference signal physical uplink shared channel mode for the first component carrier and a cyclic shift indicator field;
determining whether the demodulation reference signal physical uplink shared channel mode for the first component carrier comprises a mirror cell mode; and
in response to determining that the demodulation reference signal physical uplink shared channel mode comprises a mirror cell mode, determining a demodulation reference signal sequence based at least in part on the cyclic shift indicator field.

2. The method of claim 1, where determining the demodulation reference signal sequence comprises determining an orthogonal cover code and an interleaved frequency division multiplexing comb combination for the first component carrier.

3. The method of claim 2, where determining the demodulation reference signal sequence further comprises determining a cyclic shift for the orthogonal cover code and the interleaved frequency division multiplexing comb combination based at least in part on the cyclic shift indicator field.

4. The method of claim 1, further comprising determining whether the demodulation reference signal physical uplink shared channel mode for the first component carrier comprises a basic cell instance; and
in response to determining that the demodulation reference signal physical uplink shared channel mode comprises a basic cell instance, determining a demodulation reference signal sequence based at least in part on the cyclic shift indicator field.

5. The method of claim 1, where the message is received via radio resource control signaling.

6. The method of claim 1, where the carrier aggregation comprises an aggregation of the first component carrier and at least one other component carriers; and
the method further comprising receiving carrier aggregation configuration messages for each of the at least one other component carriers.

7. The method of claim 1, further comprising transmitting, from the user equipment, a message for coordinated multi-point reception based on the determined demodulation reference signal sequence.

8. The method of claim 1, where the indication of a demodulation reference signal physical uplink shared channel mode comprises an uplink specific carrier indicator field.

9. The method of claim 1, where the message comprises a carrier aggregation configuration message.

10. An apparatus, comprising at least one processor; and at least one memory including computer program code, the at least one memory and the computer program code configured to, with the at least one processor, cause the apparatus to perform at least the following:
to receive a message for a first component carrier from a network node,
where the message comprises an indication of a demodulation reference signal physical uplink shared channel mode for the first component carrier and a cyclic shift indicator field;
to determine whether the demodulation reference signal physical uplink shared channel mode for the first component carrier comprises a mirror cell mode; and
in response to determining that the demodulation reference signal physical uplink shared channel mode comprises a mirror cell mode, to determine a demodulation reference signal sequence based at least in part on the cyclic shift indicator field.

11. The apparatus of claim 10, where, when determining the demodulation reference signal sequence, the at least one memory and the computer program code are further configured to cause the apparatus to determine an orthogonal cover code and an interleaved frequency division multiplexing comb combination for the first component carrier.

12. The apparatus of claim 11, where, when determining the demodulation reference signal sequence, the at least one memory and the computer program code are further configured to cause the apparatus to determine a cyclic shift for the orthogonal cover code and the interleaved frequency division multiplexing comb combination based at least in part on the cyclic shift indicator field.

13. The apparatus of claim 10, where the at least one memory and the computer program code are further configured to cause the apparatus to determine whether the demodulation reference signal physical uplink shared channel mode for the first component carrier comprises a basic cell instance; and
in response to determining that the demodulation reference signal physical uplink shared channel mode comprises a basic cell instance, to determine a demodulation reference signal sequence based at least in part on the cyclic shift indicator field.

14. A computer readable medium tangibly encoded with a computer program executable by a processor to perform actions comprising:
receiving, at a user equipment, a message for a first component carrier from a network node,
where the message comprises an indication of a demodulation reference signal physical uplink shared channel mode for the first component carrier and a cyclic shift indicator field;
determining whether the demodulation reference signal physical uplink shared channel mode for the first component carrier comprises a mirror cell mode; and
in response to determining that the demodulation reference signal physical uplink shared channel mode comprises a mirror cell mode, determining a demodulation reference signal sequence based at least in part on the cyclic shift indicator field.

15. The computer readable medium of claim 14, where determining the demodulation reference signal sequence comprises determining an orthogonal cover code and an interleaved frequency division multiplexing comb combination for the first component carrier.

16. The computer readable medium of claim 15, where determining the demodulation reference signal sequence further comprises determining a cyclic shift for the orthogonal cover code and the interleaved frequency division multiplexing comb combination based at least in part on the cyclic shift indicator field.

17. The computer readable medium of claim 14, where the actions further comprise determining whether the demodulation reference signal physical uplink shared channel mode for the first component carrier comprises a basic cell instance; and
in response to determining that the demodulation reference signal physical uplink shared channel mode comprises a basic cell instance, determining a demodulation reference signal sequence based at least in part on the cyclic shift indicator field.

18. An apparatus comprising:
means for receiving a message for a first component carrier from a network node,
where the message comprises an indication of a demodulation reference signal physical uplink shared channel mode for the first component carrier and a cyclic shift indicator field;
mode determining means for determining whether the demodulation reference signal physical uplink shared channel mode for the first component carrier comprises a mirror cell mode; and
sequence determining means for determining a demodulation reference signal sequence based at least in part on the cyclic shift indicator field in response to determining that the demodulation reference signal physical uplink shared channel mode comprises a mirror cell mode.

19. The apparatus of claim 18, where the sequence determining means comprises means for determining an orthogonal cover code and an interleaved frequency division multiplexing comb combination for the first component carrier.

20. The apparatus of claim 18, where the apparatus further comprises means of determining whether the demodulation reference signal physical uplink shared channel mode for the first component carrier comprises a basic cell instance; and
means for determining a demodulation reference signal sequence based at least in part on the cyclic shift indicator field in response to determining that the demodulation reference signal physical uplink shared channel mode comprises a basic cell instance.
